(19) United States
(12) Patent Application Publication
(10) Pub. No.: US 2024/0395439 A1
(43) Pub. Date: Nov. 28, 2024

(54) INSULATED CONDUCTOR AND METHOD OF MANUFACTURE

(71) Applicant: VICTREX MANUFACTURING LIMITED, Thornton Cleveleys, Lancashire (GB)

(72) Inventors: Colin Rimmer, Thornton Cleveleys, Lancashire (GB); James Bonnett, Thornton Cleveleys, Lancashire (GB)

(21) Appl. No.: 18/693,862

(22) PCT Filed: Sep. 5, 2022
(86) PCT No.: PCT/GB2022/052257

§ 371 Date: Mar. 20, 2024

(30) Foreign Application Priority Data
Sep. 24, 2021 (GB) 2113671.8

(51) Int. Cl. H01B 3/42; H01B 3/30; H01B 13/14; H02K 3/30; H02K 15/10

(52) U.S. Cl. CPC H01B 3/427; H01B 3/307; H01B 13/14; H02K 3/30; H02K 15/105

(57) ABSTRACT

An insulated electrical conductor having an improved corona resistance, the insulated conductor comprising an electrical conductor adapted to have an electrical potential difference applied across it to induce a flow of electrical current, the conductor comprising a surface, wherein a layer of insulating polymeric compound is provided above the surface, wherein the insulating polymeric compound comprises a continuous phase of polymeric material comprising polyaryl ether ketone (PAEK) polymer including a repeat unit of the general formula I wherein t1 and w1 independently represent 0 or 1 and v1 represents 0, 1 or 2; and wherein the polymeric insulating compound also comprise a dispersed phase of solid particulate material.

—O-Ph-(O-Ph)ₜ₁-CO-Ph-(O-Ph)_{w1}-(CO-Ph)ᵥ₁

### TECHNICAL FIELD

The present invention relates to an insulated electrical conductor suitable for use as magnet wire in a stator of an electric motor and having improved corona resistance, a method of manufacture thereof and an electrical device comprising the insulated electrical conductor.

### BACKGROUND AND PRIOR ART

Electrical insulating material, such as polymeric insulators are widely used in electrical components. Polymers have the advantages of being naturally electrically insulating, as well as capable of being flexible and resistant to electrical or thermal breakdown.

Insulated electrical conductors are installed in almost all electrical devices to conduct electricity without causing short circuits that may be caused by the contact of non-electrically insulated conductors.

Electrical devices such as electric motors, alternators and generators comprise a stator and a rotor. The stator comprises a metallic core with electrically insulated wire winding through the core to form the stator coil. When alternating current passes through the core, magnetic fields are formed which cause a rotor, associated with the stator, to rotate. So-called magnet wire must be electrically insulated, and various methods of carrying this out have been suggested. This includes using one or more layers of polymer insulation around a circular or rectangular cross-section wire. It is common that such wire comprises more than one polymeric insulating coating, e.g. a thermoplastic material with a thermoset polymer.

The development of electrically powered vehicles has presented new technical challenges in this area. As the technology develops, higher voltages are required and a resulting higher resistance to thermal and electrical stresses are needed. Thus the requirements of electrical insulators are becoming more demanding.

The technical demands on such insulating material are therefore very high indeed. The polymer must be electrically insulating, tough, corrosion resistant, processable, and have an acceptably high voltage endurance and resistance to voltage-induced breakdown.

Polyaryl ether ketones (PAEKs) such as polyether ether ketone (PEEK) are often used as high performance thermoplastic polymers. PEEK is the material of choice for many commercial applications because it forms a semi-crystalline solid, when solidified from the melt, with outstanding mechanical and chemical resistance properties. PEEK melts at about 343° C. and has a Tg of about 143° C.

WO2014/207458 discloses copolymers of PEEK and PEDEK which have higher than expected crystallinities and can be part of a composition which includes a filler means which may be fibrous such as glass fibre, carbon fibre, asbestos fibre, silica fibre, alumina fibre, zirconia fibre, boron nitride fibre, silicon nitride fibre, boron fibre, fluorocarbon resin fibre and potassium titanate fibre, or non-fibrous such as mica, silica, talc, alumina, kaolin, calcium sulphate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulphate. Such materials may be made as described in Impregnation Techniques for Thermoplastic Matrix Composites, A. Miller and A G Gibson, Polymer & Polymer Composites 4 (7), pp 459-481 (1996), EP102158 and EP102159.

WO2016/120592 discloses a conductor wire coated in a preferably homogeneous PAEK polymer e.g. a tape having at least 25% crystallinity.

However, such materials, whilst having excellent electrical insulator properties, require additional steps to improve their adherence to common electrical conductor materials such as copper and aluminium. Additionally, at higher voltages required of more demanding applications, such as higher voltage electric motors, resistance to corona formation is not always at a sufficient level.

US 2019/0131037 discloses an insulated electric conductor wire with an insulating thermoplastic coating that is preferably PAEK, subjected to gas plasma treatment to remove any oxide layer and improve the adhesion of the thermoplastic coating thereto.

EP 2843668 B1 discloses an insulated electric conductor wire coated in an intermediate thermoset polymer (e.g. PEI) layer to improve the adhesion of the thermoplastic insulating coating (e.g. PEEK). US 2020/0312535 A1 discloses a further example of an embodiment with a thermoset enamel intermediate layer. Further improvements in the area of polymeric electrical insulators are therefore of continuing importance.

### DETAILED DESCRIPTION OF THE INVENTION

In a first aspect, the invention relates to an insulated electrical conductor having an improved corona resistance, the insulated conductor comprising an electrical conductor adapted to have an electrical potential difference applied across it to induce a flow of electrical current, the conductor comprising a surface, wherein a layer of insulating polymeric compound is provided above the surface, wherein the insulating polymeric compound comprises a continuous phase of polymeric material comprising polyaryl ether ketone (PAEK) polymer including a repeat unit of the general formula I:

—O-Ph-(O-Ph)ₜ₁-CO-Ph-(O-Ph)_{w1}-(CO-Ph)ᵥ₁ (formula I)
wherein t1 and w1 independently represent 0 or 1 and v1 represents 0, 1 or 2; and wherein the polymeric insulating compound also comprise a dispersed phase of solid particulate material.

It has been found that a PAEK polymer that comprises a distribution of solid particulate material, provides a significant improvement in thermal conductivity without reducing electrical insulating properties, and provide improved partial discharge and corona resistance. Additionally, it has been found that such materials have improved adherence to copper and aluminium than PAEK without any filler material.

The materials may therefore be used in a wide variety of electrical components, providing excellent electrical insulating properties for high performance applications, particularly but not exclusively as a winding wire in a stator of an electric motor, generator or alternator.

### Insulating Polymeric Compound

Preferably the insulating polymeric compound comprises at least 65 wt % of the polymeric material, more preferably at least 75 wt %, more preferably at least 85 wt %. In general, the remainder will be made up of the solid particulate material, as discussed below.

### Polymeric Material

The polymeric material is a thermoplastic and may comprise at least 50 wt % of the PAEK polymer of formula I, more preferably at least 70 wt %, most preferably at least 80 wt %. The remainder may be provided by a copolymer, as discussed below, and/or by a blend with other polymers. If blended with another polymer, such polymers may be selected from the list consisting of polyphenylsulphone, polyetherimide, polyethersulphone, polyphenylene sulphide, polycarbonate, polyester or mixtures thereof.

PAEK polymers or copolymers, unlike many conventional polymers, can be obtained in either amorphous or crystalline form as a direct result of the way that the polymer is treated. A glassy or amorphous state is achieved by rapidly quenching the polymer from the melt to below Tg, whereas slow-cooling the polymer from the melt will allow crystallinity to develop in the sample (melt crystallisation). The crystalline form of the polymer can also be obtained from the polymer in its amorphous state, for instance at room temperature, by heating it to a temperature higher than Tg but less than Tm (cold crystallisation) prior to cooling back to room temperature, or by holding the polymer at a constant temperature between Tg and Tm for a length of time (isothermal crystallisation) prior to cooling back to room temperature.

A PAEK polymer in the context of the present invention is one having a repeating unit of formula 1:

—O-Ph-(O-Ph)ₜ₁-CO-Ph-(O-Ph)_{w1}-(CO-Ph)ᵥ₁ (formula I)

wherein t1 and w1 independently represent 0 or 1 and v1 represents 0, 1 or 2

The linkages between adjacent phenyl groups are typically predominantly in a “para” 1, 4 relationship, as depicted in formula II:

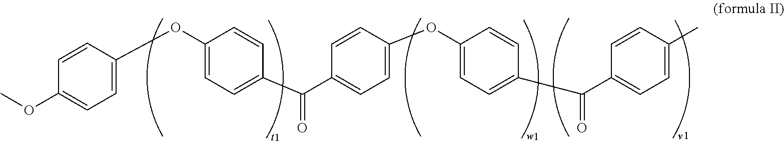

However, some proportion of the PAEK may be in a “meta” 1, 3 or “ortho” 1, 2 relationship. As used throughout, unless otherwise specified, linkages are of the “para” arrangement.

PAEKs, particularly including PEEK, can be manufactured by nucleophilic polycondensation of bisphenols with organic dihalide compounds in a suitable solvent in the presence of alkali metal carbonates and/or bicarbonates or alkaline earth metal carbonates and/or bicarbonates. Such processes are set out, for example, in EP0001879A, EP0182648A, EP0244167A and EP3049457A.

Preferably the PAEK has a crystallinity of at least 10%, more preferably at least 20%. However, for some applications a lower crystallinity such as less than 25% or less than 22% may be advantageous, particularly when the PAEK is to be extruded.

In a preferred embodiment, the crystallinity of said PAEK material is suitably at least 25% (preferably at least 28%, more preferably at least 30%) across substantially the entire extent of said insulating layer. The crystallinity of said PAEK is preferably substantially constant across the extent of said insulating layer. Suitably, the crystallinity of said PAEK in said layer varies by less than 10%. For example, the difference between the minimum crystallinity and the maximum crystallinity of said material in the layer is less than 10%. Said insulting layer is preferably devoid of areas (often referred to as amorphous patches) wherein the crystallinity is less than 15%. Crystallinity of said polymeric material described in any statement herein may be less than 40%. Said insulating layer is preferably homogenous, suitably across its entire extent.

Crystallinity is measured by a DSC to determine the onset of Tg by the intersection of the lines drawn along the pre-transition baseline and a line drawn along the greatest slope obtained during the transition. The Tn is measured as the temperature at which the main peak of the cold crystallisation exotherm reaches a maximum. The Tm is the temperature at which the main peak of the melting endotherm reached a maximum. The heat of fusion for melting (ΔHm) is obtained by connecting the two points at which the melting endotherm deviates from the relatively straight baseline. The integrated area under the endotherm as a function of time yields the enthalpy (mJ) of the melting transition: the mass normalised heat of fusion is calculated by dividing the enthalpy by the mass of the specimen (J/g). The level of crystallisation (X (%) is determined by dividing the heat of fusion of the specimen by the heat of fusion of a totally crystalline polymer, which for polyether ether ketone is 130 J/g. ISO 11357-1 to ISO 11357-4 describes the test methodology used to determine said measurements.

A preferred PAEK is polyether ether ketone (PEEK), wherein the repeat units are wherein t1=1, v1=0 and w1=0.

The PAEK, e.g. PEEK, may also include other repeating units to form a copolymer. A particularly preferred copolymer contains repeating units of PEEK and polyether diphenyl ether ketone (PEDEK). Suitable copolymers of PEEK and PEDEK are disclosed in EP0184458A.

PEDEK is a polymer having a repeating unit of

—O-Ph-Ph-O-Ph-CO-Ph (formula III)

The PEEK-PEDEK copolymer is disclosed as having similar chemical resistance and mechanical properties to PEEK, but also as having a lower Tm than PEEK, but a similar or higher Tg value than PEEK.

WO 2014/207458 A1 discloses a suitable PEEK-PEDEK copolymer manufactured by a process comprising polycondensing a mixture of at least one dihydroxybenzene compound and at least one dihydroxybiphenyl compound in the molar proportions 65:35 to 95:5 with at least one dihalobenzophenone in the presence of sodium carbonate and potassium carbonate, where the mole % of potassium carbonate, used in the synthesis of the PEEK-PEDEK copolymer by nucleophilic polycondensation, is at least 2.5, where the mole % of potassium carbonate is expressed as a percentage of the total number of moles of the hydroxy monomers used in the synthesis. The PEEK-PEDEK copolymers of WO 2014/207458 A1 have higher crystallinity of the resulting PEEK-PEDEK copolymer compared to that disclosed that for the copolymers of EP0184458A.

Suitable PEEK-PEDEK copolymers are also disclosed in WO 2019/186085 A1 which discloses their formation by a specific nucleophilic polycondensation process including polymerisation-stopping (for instance using lithium salt) and end-capping of the copolymer (to provide specific end units to the copolymer), in the presence of reduced quantities of aromatic sulfone solvent, to provide PEEK-PEDEK copolymers with reduced chain branching and reduced melt viscosity at low shear rates compared to prior art copolymers of comparable molecular mass.

Further useful copolymers are provided in GB2108948.7 which discloses a copolymer consisting essentially of repeat units of PEEK and PEDEK, wherein the PEEK is comprised of proportions of PEEK (i.e. in the “para” configuration), mPEEK (i.e. in the “meta” configuration) and oPEEK (i.e. in the “ortho” configuration). A particularly preferred polymer is the one provided for in example 19 thereof, which is a PEEK-oPEEK-PEDEK copolymer in a ratio of 65:15:20 including 1,2-dihydroxybenzene as comonomer.

According to an aspect of the invention, there is provided an insulated electrical conductor assembly having improved corona resistance, the assembly comprising an electrical conductor adapted to have an electrical potential difference applied across it to induce a flow of electrical current, wherein an insulating polymeric compound is provided on the assembly, wherein the insulating polymeric compound comprises polyaryletherketone, PAEK, wherein the PAEK is a copolymer comprising repeat units of formula

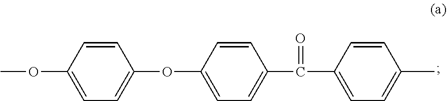

and
repeat units of formula

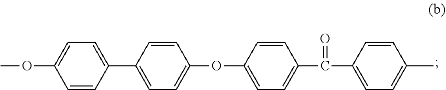

wherein at least 95 mol % of the copolymer repeat units are repeat units of formula (a) and of formula (b);
wherein the repeat units (a) and (b) have a molar ratio (a):(b) from 55:45 to 80:20; and
wherein the PAEK has a melt viscosity, MV, from 0.35 to 0.55 kNsm⁻² as measured using capillary rheometry at 400° C. at a shear rate of 1000 s⁻¹ by extrusion through a tungsten carbide capillary die of 0.5 mm diameter and 8.0 mm length.

Preferably, the polymeric insulating compound of the above mentioned formula (a):(b) also comprises a dispersed phase of solid particulate material. Preferably, the solid particulate material is selected from the group comprising barium sulphate, calcium sulphate, chromium oxide, glass fibre, iron oxide, magnesium carbonate, magnesium oxide, mica, silica, silicon carbide, silicon dioxide (quartz), silicon nitride, sodium silicate, titanium dioxide, talc (e.g. Jetfine™), zinc oxide, zirconia, boron nitride, wollastonite, aluminium nitride, or mixtures thereof. Preferably, the solid particulate material is present at a fill level of from 0.1 to 35 wt %, preferably from 0.5 to 30 wt %, more preferably from 1 to 20 wt %. In one embodiment, an insulated electrical conductor is provided comprising the insulating polymeric compound of the above mentioned formula (a):(b) comprising substantially 20 wt % talc. Preferably, said solid particulate material has a d50 between 0.001 to 50 μm.

For the sake of conciseness, units of formula (a) and formula (b) are referred to as PEEK and PEDEK respectively in this specification. Typically, the polymer will also have end units of the polymer, which may be the same as the repeat units, but with a terminal OH or F group. However, the process for forming the polymer may include a separate end-capping step at completion of polymerisation, in which case separate monomer or reagent may be added as end-capping agent so that the end units may differ from the repeat units of the polymer. Such end-capping is well known in the field of nucleophilic polycondensation reactions. In other words, for the polymer of the invention, 95 mol % or more of all repeat units present are units of formula (a) and of formula (b) in the specified molar ratio (a):(b) from 55:45 to 80:20. This may be established by virtue of knowledge of the numbers of moles of monomers employed in in the preparation of the polymer. The phenylene moieties in each repeat unit (a) and (b) have 1,4-para linkages to atoms to which they are bonded. This results in the polymeric material being crystalline in nature. Preferably, the MV of the PAEK of the first aspect of the invention, measured at 1000s⁻¹ and at 400° C. as described above is from 0.40 to 0.50 kNsm⁻². Preferably, the molar ratio (a):(b) is from to 60:40 to 75:25. Preferably, at least 98 mol % of the copolymer repeat units are repeat units of formula (a) and of formula (b), more preferably 99 mol %. Most preferably, the polymer consists essentially of repeat units of formula (a) and formula (b).

In this context, the term “consists essentially of” means that the no other monomers are deliberately included, although some may be present as unavoidable impurities or as end groups.

### Electrical Properties

Once the solid particulate material is included into the polymeric material, there is a surprising improvement in partial discharge and corona resistance, whilst retaining its other physical properties that make it suitable for use as an insulator. In one particular embodiment incorporating talc filled material, the inventors saw a surprising improvement in corona resistance. In such an arrangement, it is envisaged that the thickness of the insulating coating could be reduced, for example, from 200 μm to 100 μm.

The insulating polymeric compound retains its electrical resistance due to the fact that the solid particulate material is dispersed, and preferably has an electrical resistance, as measured in the direction perpendicular to the surface of the electrical conductor, of at least 10¹⁰ Ω·cm.

The insulating polymeric compound preferably has a dielectric strength (i.e. breakdown voltage) of from 90 to 190 kV/mm. The dielectric strength will alter depending on the thickness of material. For example, an insulating coating of approximately 2 mm will have a dielectric strength of less than 50 kV/mm. Conversely, an insulating coating thinner than 2 mm, for example 8 μm, would have a breakdown voltage of greater than 300 kV/mm.

The arrangement provided by the invention, allows for improved corona resistance, leading to greater lifetimes of the insulator in demanding electrical applications, for example, evidenced by voltage endurance data.

Additionally, the insulating polymeric compound preferably has a relative permittivity of less than 3.8, preferably less than 3.5, more preferably less than 3.3.

The insulating polymeric compound preferably has a thermal conductivity, as measured in the direction perpendicular to the surface of the electrical conductor, of at least 0.15 Wm⁻¹K⁻¹, preferably at least 0.2 Wm⁻¹K⁻¹, more preferably at least 0.25 Wm⁻¹K⁻¹.

### Thicknesses

The insulating polymeric compound may have a dimensional thickness, as defined in the direction perpendicular to the surface of the electrical conductor, which is appropriate to the application. Preferably the polymeric material has an average thickness of from 2 to 500 μm, more preferably from 2 to 300 μm, preferably 10 to 300 μm.

The thickness of the insulating layer is preferably substantially constant across the extent of the insulating layer. Thus, preferably, the ratio defined as the thickness of the insulating layer at its thinnest point divided by the thickness of the insulating layer at its thickest point is at least 0.8, preferably at least 0.9, more preferably at least 0.95. In one embodiment, said insulating layer is not covered with another material, for example another layer.

### Shape of the Conductor

The electrical conductor may take any shape or form provided it is designed and adapted to carry electrical current through it by applying a potential difference across it in use. Such electrical conductors may, for example, be elongate, planar or be three dimensional. In each case the electrical conductor will have an external surface, which may be flat or curved, onto which the insulating polymeric compound of the present invention may be applied.

A preferred electrical conductor is a wire, e.g. magnet wire, which may have a circular or rectangular or other cross-section, for example, triangular or hexagonal in cross section. When the conductor is a wire then the direction tangential to the surface is also parallel to the length of the wire. An alternative wire may comprise a tailored profile to be used with, for example, a variable thickness insulating polymeric compound.

Such wires find particular utility as magnet wires in an electrical motor, e.g. a winding around a stator coil. This is particularly advantageous for high performance motors, where partial discharge and corona resistance are particularly desirable physical properties.

### Material of the Conductor

The electrical conductor is preferably essentially copper or aluminium, although the present invention is applicable to a wide range of electrical conductor materials, for example, nickel or silver. In one embodiment, the conductor may comprise a copper core conductor that has been plated with a suitable material, for example, silver or nickel. When the conductor is copper it is preferably a low oxygen copper with an oxygen content of less than 30 ppm, more preferably less than 20 ppm.

### Particle Size

The solid particulate material of the present invention may comprise particles that are non-spherical and so it is important to characterise their size accordingly. A preferred particle size measurement is the Sauter mean diameter, or d3,2, which is the diameter of the sphere that has the same ratio of surface area to volume as the sample of particles. This measure of particle size takes into account deviation from a spherical particle shape. For example, as non-spherical particles have a greater surface area for the size of the particles, than spherical particles, they will have a correspondingly smaller value of d3,2. Preferably the solid particulate material has a d3,2 of from 0.001 to 50 μm, more preferably from 0.005 to 15 μm.

The d50 may be between 0.001 to 50 μm, more preferably from 0.005 to 15 μm. In one arrangement, the solid particulate material has a d50 of from 0.001 to 50 μm, more preferably from 0.005 to 15 μm.

### Particle Shape

In one embodiment of the invention, the solid particulate material is made up of particles having a length and a width, such that each particle has an orientation angle of from 0 to 90 degrees, the orientation angle being the angle between the direction of its length to a direction tangential to the surface nearest the particle, and wherein the particles are oriented within the insulating polymeric compound such that a number average of the orientation angles is less than 45 degrees. It has been found that such elongate particles, when aligned with the surface of the conductor, provide further improved electrical and thermal properties.

Preferably the particles are oriented within the insulating polymeric material such that a number average of the orientation angles is less than 30 degrees, more preferably less than 20 degrees. The more aligned the particles are with the surface of the electrical conductor, the greater the electrical insulation properties of the polymer, whilst still providing additional technical benefits such as adhesion, corona resistance and thermal breakdown.

If the particles forming the solid particulate material are significantly non-spherical they may also be suitably characterised by an aspect ratio. Such an aspect ratio would be a ratio of a maximum length of a particle to a minimum width of the particle, wherein the width is perpendicular to the length. Each particle in a population will have its own aspect ratio due to natural variation, however a number mean aspect ratio of at least 2:1 is preferred, more preferably at least 4:1.

Another suitable method of characterising the solid particulate material is sphericity, defined as the surface area of a sphere having the same volume as the particle divided by the surface area of the particle. Preferably the mean sphericity of the solid particulate material is less than 0.7, more preferably less than 0.6, although particles of any sphericity have been found to be advantageous.

In one embodiment, the solid particulate material may comprise particles being substantially symmetrical about a line of symmetry.

### Solid Particulate Material

A wide variety of materials may form the solid particulate material as long as they have the suitable particle size, and especially materials with a high thermal conductivity such as minerals. Examples of such materials include calcium sulphate, chromium oxide, glass fibre, iron oxide, magnesium carbonate, magnesium oxide, mica, silica, silicon carbide, silicon dioxide (quartz), silicon nitride, sodium silicate, titanium dioxide, talc (e.g. Jetfine™ including Jetfine 3CA), zinc oxide, zirconia, barium sulphate, boron nitride, wollastonite, aluminium nitride.

It has been found that below a minimum amount of solid particulate material the beneficial effects of the present invention become minimal and that above a certain amount beneficial properties of the polymer become diminished. As such it is preferable that the solid particulate material is present in the insulating polymeric material at a fill level of from 0.1 to 50 wt %, or 0.1 to 40 wt %, 0.1 to 35 wt %, more preferably from 0.5 to 30 wt %, more preferably from 1 to 20 wt %, most preferably from 15 to 25 wt %. For example, 5% or 10% or 15% titanium dioxide may be present in the PAEK, preferably PEEK. Alternatively, 5% or 10% or 15% barium sulphate may be present in the PAEK, preferably PEEK. In a further alternative example, 5% or 10% or 15% or 20 wt % talc may be present in the PAEK, preferably PEEK.

In one preferred embodiment, an insulated electrical conductor comprises the insulating polymeric compound, for example, preferably PEEK, or alternatively preferably the copolymer PEEK-PEDEK as hereinbefore described, and solid particulate material of between 10-30 wt %.

In an embodiment, an insulated electrical conductor comprises the insulating polymeric compound, preferably being PEEK, or preferably the copolymer PEEK-PEDEK, and 20 wt % talc.

In one embodiment, 5% or 10% or 15% barium sulphate may be present in the PAEK, preferably PEEK-PEDEK. In a further alternative example, 5% or 10% or 15% or 20% or 30% talc may be present in the PAEK, preferably PEEK-PEDEK.

### Additional Layers

Although the polymeric material may be applied directly to the surface of the electrical conductor, an additional layer of material may also be present between the insulating polymeric material and the electrical conductor. Such additional layers are often termed enamel layers and may include a further polymer layer, e.g. a thermoset polymer layer e.g. a fluoropolymer or polyimide layer. Likewise an additional layer may be provided above the electrical insulating polymeric compound, as desired according to the application of the electrical component.

### Method of Formation

In a second aspect, the invention relates to a method of manufacturing an insulated electrical conductor as described herein, the method comprising the steps of:
a) blending together a source of flowable polymeric material with the solid particulate material to form a random blend; and
b) exposing the random blend to shear forces; and
c) simultaneously or subsequently laying down the blend onto the surface of an electrical conductor.

In a particularly preferred method of manufacture, the insulated electrical conductor is manufactured by a process including the step of extrusion of a flowable mass of polymeric material comprising the solid particulate material.

The insulating polymeric compound may be made prior to application onto the electrical conductor, or may deposited directly onto electrical conductor, for example, as it is being formed, e.g. in an extrusion process.

If the insulating polymeric compound is made prior to application onto the electrical conductor, the insulated electrical conductor of the present invention may be made by laying down a layer of insulating polymeric compound above the surface of the electrical conductor. For example, when the electrical conductor is a wire then a process of wrapping layers of polymer in the manner disclosed in WO2016/120592 may be employed.

As already discussed, the insulating electrical conductor is of particular utility as a magnet wire in a stator of an electric motor. Therefore, in a third aspect, the invention relates to an electrical device comprising an insulated electrical conductor as described herein. For example, such an electrical device comprising an insulated electrical conductor may be a vehicle motor assembly.

### EXAMPLES

### Adhesion Test

Samples of PEEK polymer having a shear viscosity of 90 Pa·s at 400° C. were tested for their adhesion to aluminium, copper, copper beryllium and stainless steel substrates with varying levels of solid particulate material inclusion. The degree of adhesion was measured by the T-peel test BS EN ISO 113399.

The following machine settings were used: Instron-2736-015, Peel rate: 50 mm per minute, PEEL extension: 200 mm, Load cell: 30KN.

Insulating polymeric compounds were prepared wherein the polymeric compound was either a first PAEK (PEAK1) having a shear viscosity of 90 Pa·s at 400° C. or a second PEAK having a lower melting point (PEAK2) and a shear viscosity of 117 Pa·s at 400° C. PAEK 2 comprised a PEEK PEDEK copolymer as hereinbefore described.

The polymers were prepared without any solid particulate material, with 20 wt % talc (Jetfine™) and/or 15 wt % glass particles.

The polymer films were prepared according to the following protocol:

An aluminium frame was cut out to 150×150 mm. Both sides of the frame were coated in Frekote™ to prevent the plastic sticking to the frame or holder, this frame was sandwiched in between two more aluminium sheets which were also coated in Frekote™ on the inner side of each sheet. The hot press was heated to 400° C. 10 g of polymer was weighed out and placed in the middle of the frame. The sandwiched in frame was then placed between two metal plaques to hold the sample in place. This was then pressed with no pressure for 4 minutes. After the 4 minutes the sample was pressed at 5 tonnes of pressure for a further 2 minutes. The sample was then removed from the hot press and quenched in water for rapid cooling

### Method of T-Peel Sample Preparation:

Heat the hot press to 400° C. The metal samples were cut into 75×200 mm strips and pre-treated accordingly. The pressed polymer film was cut into 75×150 mm strips. The film was then sandwiched in between two pre-treated metal strips leaving a 50 mm tab on the end for the Instron grips to grab onto. This sample was then placed in between two 200×200 mm aluminium sheets to prevent spillage onto the press. This sample was then placed onto two metal plaques. The samples were pressed under no pressure for 2 minutes. Once finished again the samples were removed from the press and quenched. The sample is further required to be cut to size into 25×200 mm samples, this gave triplicate samples for each metal, compound and surface treatment.

The results are presented below in tables 1 to 4.

TABLE 1
Peel values for Aluminium substrate

| | Polymer | | | | | |
|---|---|---|---|---|---|---|
| Surface | | PAEK1 | PAEK1 | | PAEK2 | PAEK2 |
| treatment | PAEK1 | TL20 | TL20GL15 | PAEK2 | TL20 | TL20GL15 |
| Degreased | 2.917 | 11.574 | 30.053 | 2.664 | 44.778 | 9.816 |
| Flame treated | 2.099 | 13.632 | 5.632 | 3.113 | 47.705 | 12.731 |
| Shot blasted | 5.409 | 41.805 | 35.597 | 15.948 | 49.927 | 39.373 |
| Etch 1 | 2.936 | 26.558 | 8.921 | 10.759 | 49.569 | 20.524 |
| Etch 2 | 21.183 | 37.655 | 13.535 | 45.785 | 54.364 | 35.451 |
| Average | 6.91 | 26.2 | 18.7 | 15.6 | 49.3 | 23.6 |

TABLE 2
Peel values for Copper substrate

| | Polymer | | | |
|---|---|---|---|---|
| Surface | | PAEK1 | PAEK1 | PAEK2 |
| treatment | PAEK1 | TL20 | TL20GL15 | TL20GL15 |
| Degreased | 11.946 | 53.367 | 36.742 | 40.833 |
| Flame treated | 9.521 | 24.725 | 32.216 | 21.244 |
| Shot blasted | 11.091 | 55.305 | 36.713 | 48.551 |
| Etch 1 | 14.18 | 42.548 | 24.273 | 26.368 |
| Etch 2 | 2.971 | 3.048 | 5.831 | 13.047 |
| Average | 9.9 | 35.8 | 27.2 | 30.0 |

TABLE 3
Peel values for Copper beryllium substrate

| | Polymer | | | |
|---|---|---|---|---|
| Surface | | PAEK1 | PAEK1 | PAEK2 |
| treatment | PAEK1 | TL20 | TL20GL15 | TL20GL15 |
| Degreased | 10.316 | 50.404 | 23.794 | 7.43 |
| Flame treated | 6.928 | 40.135 | 16.092 | 11.06 |
| Shot blasted | 14.897 | 24.584 | 20.441 | 37.347 |
| Etch 1 | 28.512 | 31.347 | 17.785 | 36.983 |
| Etch 2 | 13.187 | 34.132 | 24.929 | 47.954 |
| Average | 14.8 | 36.1 | 20.6 | 28.2 |

TABLE 4
Peel values for Stainless steel substrate

| | Polymer | | | |
|---|---|---|---|---|
| Surface | | PAEK1 | PAEK1 | PAEK2 |
| treatment | PAEK1 | TL20 | TL20GL15 | TL20GL15 |
| Degreased | 9.464 | 20.834 | 12.03 | 29.382 |
| Flame treated | 10.808 | 25.539 | 20.841 | 28.664 |
| Shot blasted | 4.769 | 36.316 | 23.465 | 18.769 |
| Etch 1 | 10.983 | 44.476 | 35.382 | 46.757 |
| Etch 2 | 28.323 | 49.554 | 39.439 | 26.759 |
| Average | 12.9 | 35.3 | 26.2 | 30.1 |

From these results it is clear that the talc filler has a definite effect on adhesion and the talc filler seems to improve adhesion most drastically when a metal is shot blasted or acid etched. As the surface area of the electrical conductor is increased with both of these techniques it would make sense why the talc would improve adhesion, as with talc having a plated structure it will have a larger surface area and the plates may be aligning with the surface better getting more intimate contact at the metal polymer interface. This would support a physical key type bond onto the metal surface.

Advantageously, the provision of a filler, for example talc, helps to reduce the coefficient of thermal expansion (CTE). Stresses at the interface between the metal and PAEK are reduced, therefore maintaining good adhesion.

### Voltage Endurance Test

This involves applying a piece of film between two electrodes and measuring the time to failure when applying e.g. 2.83 kVrms at 1 KHz. The test system used consists of a 5 kV transformer that can be driven at frequencies between 400 Hz and 2 kHz to produce a sinusoidal voltage with a maximum output of 5 kVrms. A series resistor is used to limit the maximum current that can flow on sample failure. The voltage then passes to the test electrodes via a voltage divider used to monitor the system voltage during tests and finally into a high voltage relay. The high voltage relay is used to isolate the supply to the failed sample. The electrodes on either side of the film sample are separated by a thickness of film (polished 50 mm base electrode and a polished 25 mm upper electrode having a 1 mm radius of curvature on its edges).

The PEEK unfilled film referred to in Table 5 had a sheer viscosity of approximately 291 Pa·s according to ISO11443.

TABLE 5
Voltage Endurance Test, time to failure (Hrs:Mins:Sec)

| Film | 30% | 20% | Unfilled |
|---|---|---|---|
| thickness (μm) | Filled PEEK | Filled PEEK | PEEK |
| 50 | 35:40:49 | 19:16:39 | 4:23:30 |
| 75 | 187:08:11 | — | 10:22:24 |
| 100 | — | 355:34:01 | 24:13:33 |

All filled films demonstrated longer lifetime than those without any solid particulate material. Theory suggests that it is the mix of particles that suppress mechanical erosion (thinning) of the insulation layer under corona discharge that increases voltage endurance lifetime (Table 5).

### Breakdown Voltage

Breakdown voltage was assessed by applying IEC 60851-5 method to a magnet wire. The wire was subjected to 11 kV with a coating of compound comprising 86 wt % PEEK and 14 wt % talc at 100 micron coating thickness.

Advantageously, the magnet wire did not break down under the above conditions. In so doing, the applicant has demonstrated that the invention provides for improved voltage endurance without compromising other critical electrical properties, when comparing filled versus unfilled PAEK based material. Furthermore, the arrangement of the invention demonstrates improved adhesion of filled PAEK compounds to a conductor compared to unfilled PAEK material. It is commercially attractive to enable high levels of adhesion, for example to a copper conductor, as this helps to ensure the longevity of the insulation system due to the risk of delamination being minimised. Conversely, and disadvantageously, it is known to use enamel as an interface to promote adhesion which can lead to cracking or cause embrittlement after thermal exposure.

1. An insulated electrical conductor having an improved corona resistance, the insulated conductor comprising an electrical conductor adapted to have an electrical potential difference applied across it to induce a flow of electrical current, the conductor comprising a surface, wherein a layer of insulating polymeric compound is provided above the surface, wherein the insulating polymeric compound comprises a continuous phase of polymeric material comprising polyaryl ether ketone (PAEK) polymer including a repeat unit of the general formula I:
—O-Ph-(O-Ph)ₜ₁-CO-Ph-(O-Ph)_{w1}-(CO-Ph)ᵥ₁ (formula I)
wherein t1 and w1 independently represent 0 or 1 and v1 represents 0, 1 or 2; and wherein the polymeric insulating compound also comprise a dispersed phase of solid particulate material.

2. An insulated electrical conductor according to claim 1, wherein t1=1, v1=0 and w1=0 to form a polyether ether ketone (PEEK).

3. An insulated electrical conductor according to claim 1, wherein the polymeric material has a crystallinity of less than 25%.

4. An insulated electrical conductor according to claim 1, wherein the polymeric material has a crystallinity of at least 25% and less than 40%.

5. An insulated electrical conductor assembly having improved corona resistance, the assembly comprising an electrical conductor adapted to have an electrical potential difference applied across it to induce a flow of electrical current, wherein an insulating polymeric compound is provided on the assembly, wherein the insulating polymeric compound comprises polyaryletherketone, PAEK, wherein the PAEK is a copolymer comprising repeat units of formula 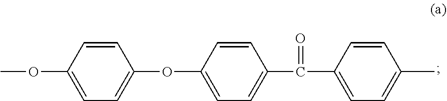
and
repeat units of formula 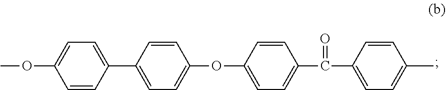
wherein at least 95 mol % of the copolymer repeat units are repeat units of formula (a) and of formula (b);
wherein the repeat units (a) and (b) have a molar ratio (a):(b) from 55:45 to 80:20; and
wherein the PAEK has a melt viscosity, MV, from 0.35 to 0.55 kNsm⁻² as measured using capillary rheometry at 400° C. at a shear rate of 1000 s⁻¹ by extrusion through a tungsten carbide capillary die of 0.5 mm diameter and 8.0 mm length.

6. An insulated electrical conductor according to claim 1, wherein the solid particulate material is selected from barium sulphate, calcium sulphate, chromium oxide, glass fibre, iron oxide, magnesium carbonate, magnesium oxide, mica, silica, silicon carbide, silicon dioxide (quartz), silicon nitride, sodium silicate, titanium dioxide, talc, zinc oxide, zirconia, boron nitride, wollastonite, aluminium nitride, or mixtures thereof.

7. An insulated electrical conductor according to claim 1, wherein the solid particulate material is present at a fill level of from 0.1 to 35 wt.

8. An insulated electrical conductor as claimed in claim 7, wherein the insulating polymeric compound comprises PEEK and 15 to 25 wt % talc.

9. An insulated electrical conductor according to claim 1, wherein the solid particulate material has a d50 between 0.001 to 50 μm.

10. An insulated electrical conductor according to claim 1, wherein the insulating polymeric compound has an average thickness of from 2 to 500 μm.

11. An insulated electrical conductor according claim 1, wherein the electrical conductor is a wire, which may have a circular or rectangular cross-section.

12. An insulated electrical conductor according to claim 11, wherein the wire is a magnet wire wound around a stator coil of an electric motor, alternator or generator.

13. An insulated electrical conductor according to claim 1, wherein the polymeric material is applied directly to the surface of the electrical conductor.

14. A method of manufacturing an insulated electrical conductor according to claim 1, the method comprising the steps of:
a) blending together a source of flowable polymeric material with the solid particulate material to form a random blend; and
b) exposing the random blend to shear forces; and
c) simultaneously or subsequently laying down the blend onto the surface of an electrical conductor.

15. A method according to claim 14, wherein step c) is carried out simultaneously by a process of extrusion.

16. An electrical device comprising an insulated electrical conductor according to claim 1.

17. An insulated electrical conductor according to claim 7, wherein the solid particulate material is present at a fill level of from 1 to 20 wt %.

18. An insulated electrical conductor as claimed in claim 8, wherein the insulating polymeric compound comprises PEEK and 20 wt % talc.

19. An insulated electrical conductor according to claim 10, wherein the insulating polymeric compound has an average thickness of from 2 to 300 μm.

20. An electrical device according to claim 16, wherein the electrical device is a vehicle motor assembly.
